(19) United States
(12) Patent Application Publication
(10) Pub. No.: US 2024/0233296 A1
(43) Pub. Date: Jul. 11, 2024

(54) METHOD AND APPARATUS FOR DETERMINING HOLDING PARAMETERS, ELECTRONIC DEVICE, AND COMPUTER MEDIUM

(71) Applicant: Beijing Zitiao Network Technology Co., Ltd., Beijing (CN)

(72) Inventors: Tongwei Lin, Beijing (CN); Kexin Wang, Beijing (CN); Long Li, Beijing (CN)

(21) Appl. No.: 18/393,616

(22) Filed: Dec. 21, 2023

(30) Foreign Application Priority Data
Jan. 11, 2023 (CN) 202310041789.4
Jan. 17, 2023 (CN) 202310094526.X

(51) Int. Cl. G06T 19/20; G06F 3/01; G06F 3/0346; G06F 3/04815; G06F 3/0484; G06F 9/451

(52) U.S. Cl. CPC G06T 19/20; G06F 3/017; G06F 3/0346; G06F 3/04815; G06F 3/0484; G06F 9/451; G06T 2200/24; G06T 2219/2004; G06T 2219/2016

(57) ABSTRACT

A method and apparatus for determining holding parameters, an electronic device and a computer medium are provided. The method includes displaying a holdable object, and a calibration object for a first user to calibrate a holding position of the holdable object; and in response to a determination instruction of the first user to determine the holding parameters of the holdable object, determining position holding parameters of the holdable object according to a first position of the holdable object and a second position of the calibration object.

### CROSS-REFERENCE TO RELATED APPLICATION

The present disclosure claims priority of the Chinese Patent Application No. 202310041789.4 file to State Intellectual Property Office on Jan. 11, 2023 and priority of the Chinese Patent Application No. 202310094526.X filed to State Intellectual Property Office on Jan. 17, 2023, the disclosures of which is incorporated herein by reference in its entirety as part of the present application.

### TECHNICAL FIELD

The present disclosure relates to a method and apparatus for determining holding parameters, an electronic device, and a computer medium.

### BACKGROUND

Virtual Reality (VR) technology is also known as virtual reality or virtual reality technology, which basic implementation is mainly based on computer technology. The latest development achievements of a variety of high technologies are used to create a realistic three-dimensional virtual world with visual, tactile, olfactory and other sensory experiences by means of computers and other devices, thus giving people in the virtual world an immersive feeling. In related arts, those skilled in the art generally relies on fixed codes when setting a holding position of a holdable object. The holding position is fixed, resulting in poor flexibility and unsatisfying user experience.

### SUMMARY

In a first aspect, the present disclosure provides a method for determining holding parameters, comprising:
displaying a holdable object, and a calibration object for a first user to calibrate a holding position of the holdable object; and
in response to a determination instruction of the first user to determine the holding parameters of the holdable object, determining position holding parameters of the holdable object according to a first position of the holdable object and a second position of the calibration object.

In a second aspect, the present disclosure provides an apparatus for determining holding parameters, comprising:
a display unit, configured to display a holdable object and a calibration object for a first user to calibrate a holding position of the holdable object; and
a determination unit, configured to determine, in response to a determination instruction of the first user to determine holding parameters of the holdable object, position holding parameters of the holdable object according to a first position of the holdable object and a second position of the calibration object.

In a third aspect, the present disclosure provides an electronic device, comprising: a processor and a memory, configured to store executable instructions of the processor. The processor is configured to execute the first aspect, or any method of possible implementations of the first aspect.

In a fourth aspect, the present disclosure provides a computer-readable storage medium on which a computer program is stored. When the computer program is executed by a processor, the first aspect or any method of possible implementations of the first aspect is implemented.

In a fifth aspect, the present disclosure provides a computer program product comprising a computer program. When the computer program is executed by a processor, the first aspect or any method of possible implementations of the first aspect is implemented.

### BRIEF DESCRIPTION OF THE DRAWINGS

In order to describe the technical solutions in the embodiments of the present disclosure or in the prior art more clearly, the accompanying drawings required in the description of the embodiments or the prior art will be described briefly below. Apparently, the accompanying drawing in the following description are some embodiments of the present disclosure, and other accompanying drawings can also be derived from these drawings by those ordinarily skilled in the art without creative efforts. In the drawings:

FIG. 1a is a schematic structural diagram of a system provided by one or more embodiments of the present disclosure;

FIG. 1b is a schematic diagram of a holdable object and a calibration object provided by one or more embodiments of the present disclosure;

FIG. 2 is a schematic flow chart of a method for determining holding parameters provided by one or more embodiments of the present disclosure;

FIG. 3 is a schematic diagram of a settings page provided by one or more embodiments of the present disclosure;

FIG. 4 is a schematic diagram of the position of a bone point of a calibration object provided by one or more embodiments of the present disclosure;

FIG. 5 is a schematic structural diagram of an apparatus for determining holding parameters provided by one or more embodiments of the present disclosure;

FIG. 6 is a schematic structural diagram of an electronic device provided by the one or more embodiments of the present disclosure;

FIG. 7 is a flow chart of a method for holding a virtual object provided by the one or more embodiments of the present disclosure;

FIG. 8 is a schematic diagram of holding a combined virtual object;

FIG. 9 is another schematic diagram of holding a combined virtual object;

FIG. 10 is a flow chart of a method for holding a virtual object provided by one or more embodiments of the present disclosure;

FIG. 11 is a schematic diagram of an entry of a configuration interface of holding parameters of a combined virtual object;

FIG. 12 is a schematic diagram of a configuration interface of a combined holding parameter or a sub-holding parameter;

FIG. 13 is a schematic diagram of the transformation of a publishing interface after the virtual object is created;

FIG. 14 is a schematic diagram of the publishing flow of a combined virtual object provided by the one or more embodiments of the present disclosure;

FIG. 15 is a schematic diagram of another transformation of a publishing interface after the virtual object is created;

FIG. 16 is a schematic structural diagram of an apparatus for holding a virtual object provided by one or more embodiments of the present disclosure;

FIG. 17 is a schematic structural diagram of an electronic device provided by one or more embodiments of the present disclosure.

### DETAILED DESCRIPTION

The following describes in detail the embodiments of the present disclosure, and examples of the embodiments are shown in the accompanying drawings. The embodiments described below with reference to the accompanying drawings are illustrative and intended to explain the present disclosure, but cannot be understood as limitations to the present disclosure.

It should be noted that the terms “first”, “second”, etc. in the description and claims of the present disclosure of the present invention, as well as the accompanying drawings, are used to distinguish similar objects, without necessarily describing a specific order or sequence. It should be understood that the data used in this way can be interchanged in appropriate cases, so that the embodiments of the present disclosure described here can be implemented in order other than those illustrated or described here, for example. In addition, the terms “comprising” and “having”, as well as any variations thereof, are intended to cover non-exclusive inclusion. For example, a process, method, system, product, or device that includes a series of steps or units, need not be limited to those clearly listed steps or units, but may include other steps or units that are not clearly listed or inherent to these processes, methods, products, or equipment.

First, some terms used in the embodiments of the present disclosure are explained below to facilitate understanding by those skilled in the art.

A circumscribed sphere refers to a circumscribed sphere of a spatial geometric figure. For rotating bodies and polyhedrons, the circumscribed sphere has different definitions. It is generally understood that the sphere surrounds the geometric body, and the vertices and arc surfaces of the geometric body are on the sphere. All the vertices of a regular polyhedron are on the same sphere surface. This sphere is called the circumscribed sphere of the regular polyhedron. Augmented Reality (AR) technology is a technology that smartly mixs virtual information with the real world. It widely uses multimedia, three-dimensional modeling, real-time tracking and registration, intelligent interaction, sensing and other technical means to simulate virtual information such as text, images, three-dimensional models, music and videos generated by a computer and then apply them to the real world. The two types of information complement each other, thus achieving “augmentation” of the real world.

Mixed Reality (MR) technology is a further development of virtual reality technology. This technology presents virtual scene information in real scenes and sets up an interactive feedback information loop among the real world, the virtual world and the user so as to enhance the sense of reality for user experience.

Virtual Reality (VR) technology is also known as virtual reality or virtual reality technology. The basic implementation is mainly based on computer technology and the latest development achievements of a variety of high technologies are used to create a realistic three-dimensional virtual world with visual, tactile, olfactory and other sensory experiences by means of computers and other devices, thus giving people in the virtual world an immersive feeling.

In related technologies, it generally relies on fixed codes when setting the holding position of a holdable object. The holding position is fixed, resulting in poor flexibility and unsatisfying user experience.

The present disclosure provides a method and apparatus for determining holding parameters, an electronic device, and a computer medium so as to solve the problem in related technologies that when setting a holding position of a holdable object in an XR scene, fixed codes are generally relied upon and the holding position is fixed, resulting in poor flexibility and unsatisfying user experience.

The technical solution of the present disclosure and how the technical solution of the present disclosure solves the above technical problems will be described in detail below with specific embodiments. The following specific embodiments can be combined with each other, and the same or similar concepts or processes can not be described again in some embodiments. The embodiments of the present disclosure will be described below with reference to the accompanying drawings.

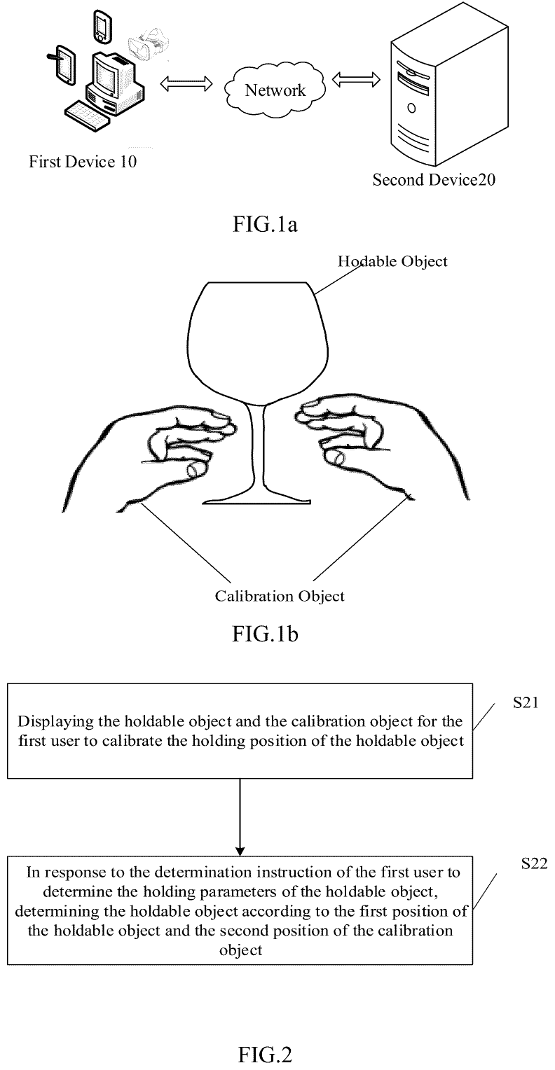

FIG. 1a is a schematic structural diagram of a system provided by one more exemplary embodiments of the present disclosure. The structure comprises: a first device 10 and a second device 20, etc.; the first device 10 and the second device 20 are connected through a network, for example, through wired or wireless network connection, etc.

Optionally, the first device 10 is provided with a display for displaying a display picture, and the display picture can be a two-dimensional picture or a three-dimensional picture. Optionally, the display picture can be a picture of any of the following scenes: a virtual reality scene, a mixed reality scene, and an augmented reality scene, and the scene can specifically be a three-dimensional space game scene or the like.

In an optional embodiment, the first device 10 can be a head-mounted display device used to be worn by the user and to interact with the user. Specifically, the user can interact with the first device 10 or the display picture in the first device 10 by using any one or more of a handheld device, voice, eyeballs, and the like.

In another optional embodiment, the first device 10 can also be a terminal device. The terminal can be a smart phone, a tablet computer, a laptop, or the like. The terminal can also comprise a client, which can be a video client, a browser client, an instant messaging client, or the like.

Optionally, the second device 20 can be a server. The server can be an independent physical server, or a server cluster or distributed system composed of multiple physical servers. The server can also be a cloud service which provides cloud services, cloud databases, cloud computing, cloud functions, cloud storage, network services, cloud communications, middleware services, domain name services, security services, Content Delivery network (CDN), and basic cloud computing services such as big data and artificial intelligence platforms.

Optionally, the second device 20 can be configured to provide the first device 10 with the aforementioned display picture.

In some embodiments, when a display picture is displayed in the first device 10, specifically, the picture content can be received from the second device 20. The second device 20 can be used to execute the following method for determining holding parameters: displaying a holdable object and a calibration object for the first user to calibrate the holding position of the holdable object; and in response to the determination instruction of the first user to determine the holding parameters of the holdable object, determining the position holding parameters of the holdable object according to the first position of the holdable object and the second position of the calibration object.

Optionally, displaying a holdable object and a calibration object for the first user to calibrate the holding position of the holdable object can also refer to controlling the display of the holdable object and the calibration object for the first user to calibrate the holding position of the holdable object.

Optionally, after the second device 20 determines the position holding parameters, the position holding parameters can also be sent to the first device 10.

Optionally, as illustrated in FIG. 1b, the holdable object can be a virtual item in the scene corresponding to the display picture. For example, the virtual item can include: a cup, a steering wheel, or the like.

Optionally, the virtual character in the scene can hold the holdable object at the holding position and control the holdable object. For example, when the holdable object is a cup, the holding position of the holdable object can be any position on the outer wall of the cup; when the holdable object is a steering wheel, the holding position of the holdable object can be the edge position of the steering wheel.

Optionally, the first user can be a relevant person involved in creating the scene.

Optionally, the calibration object can be a virtual cartoon object in the scene. For example, the calibration object can be virtual hands (as illustrated in FIG. 1b), a virtual gloves, or the like.

Optionally, the first position of the holdable object can be coordinate information of the holdable object in the above scene. The first position can be flexibly set by the first user.

Optionally, the second position of the calibration object can be coordinate information of the calibration object in the above scene.

Optionally, the position holding parameters of the holdable object can be distance information.

In another optional embodiment, when the first device 10 is a head-mounted display device, the aforementioned method for determining holding parameters of the first device 10 and the second device 20 etc. can also be executed by the first device 10 itself, and the system can also only include the first device 10, that is, the first device is an all-in-one machine. Specifically, the first device 10 is configured to: display a holdable object and a calibration object for the first user to calibrate the holding position of the holdable object; and in response to a determination instruction of the first user to determine the holding parameters of the holdable object, determine the position holding parameters of the holdable object according to a first position of the holdable object and a second position of the calibration object.

The detailed implementation of the forementioned method for determining holding parameters and the specific functions of the forementioned first device 10 or second device 20 will be described in detail below. It should be noted that the order in which the following embodiments is described is not used to limit the priority order of the embodiments.

FIG. 2 is a schematic flow chart of a method for determining holding parameters provided by one or more exemplary embodiments of the present disclosure. The execution subject of the method can be the above-mentioned first device or second device. The method at least includes S21 and S22.

S21. Displaying the holdable object and the calibration object for the first user to calibrate the holding position of the holdable object.

Optionally, the holdable object can be a virtual item in a scene corresponding to the display picture in the first device. For example, the virtual item can include: a cup, a steering wheel, or the like. It can be understood that holding can include holding by hands, or can include holding by attachment to other body parts such as limbs or the head.

Optionally, the virtual character in the scene can hold the holdable object at the holding position and control the holdable object.

For example, when the holdable object is a cup, the holding position of the holdable object can be any position on the outer wall of the cup; when the holdable object is a steering wheel, the holding position of the holdable object can be any edge position of the steering wheel.

Optionally, the first user can be a relevant person involved in creating the scene.

Optionally, the calibration object can be a part of a virtual cartoon object in the scene. For example, the calibration object can be virtual hands, virtual gloves, or the like. When the calibration object can be virtual hands or virtual gloves, there can be one or two calibration object(s). When there are two calibration objects, the two calibration objects can be the left hand and the right hand respectively, or the left hand glove and the right hand glove; the sizes of the two calibration objects can be the same or different, and the sizes of the calibration objects can be flexibly set by the relevant person. It can be understood that the calibration object can be a part of other virtual cartoon objects such as virtual limbs or the head, or the entire virtual cartoon object.

S22. In response to the determination instruction of the first user to determine the holding parameters of the holdable object, determining the holdable object according to the first position of the holdable object and the second position of the calibration object.

Optionally, the first user can trigger the determination instruction for determining the holding parameters of the holdable object by operating a preset button.

Optionally, the button can be provided on a preset settings page.

Optionally, the above method further includes: displaying a preset settings page; and determining the attributes of the holdable object according to the operation of the first user on the displayed operable control on the settings page. The settings page displays at least one of the following:
an operable control for the first user to set the release conditions of the holdable object in the grabbed state;
an operable control for the first user to set whether the holdable object, upon being released from the grabbed state, moves to the initial position before being grabbed; and
an operable control for the first user to set whether the holding position of the holdable object is a fixed position.

Correspondingly, the attributes of the holdable object can include at least one of the following:
the release conditions of the holdable object in the grabbed state;
whether the holdable object, upon being released from the grabbed state, moves to the initial position before being grabbed; and
whether the holding position of the holdable object is a fixed position.

Optionally, the settings page also displays: an operable control for the first user to set whether to set the current object as the holdable object.

Optionally, when it is determined that the first user operates an operable control for the first user to set the current object as the holdable object, display of the calibration object is triggered.

Optionally, the calibration object can have the same size as the handheld object described below.

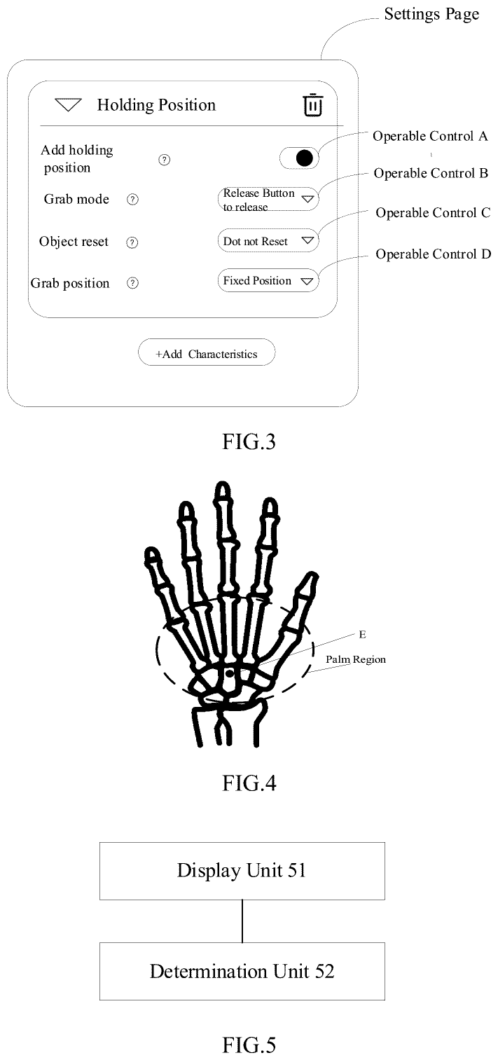

Referring to FIG. 3, FIG. 3 is a schematic diagram of a settings page provided by one or more exemplary embodiments of the present disclosure. The operable control A is an operable control used for the first user to set whether to set the current object as the holdable object, the operable control B is an operable control used for the first user to set the release conditions of the holdable object in the grabbed state, the operable control C is an operable control used for the first user to set whether the holdable object, upon being released in the grabbed state, moves to the initial position before being grabbed; and the operable control D is an operable control used for the first user to set whether the holding position of the holdable object is a fixed position.

Optionally, as further illustrated in FIG. 3, each operable control can correspond to text information for indicating the currently set attributes of the holdable object.

The condition for releasing the holdable object in the grabbed state can be to release the button or double-click the button. The button can be a button of a handle.

Optionally, when the text information corresponding to the operable control C is “reset”, the attribute information of the holdable object includes: the holdable object, upon being released in the grabbed state, moving to the initial position before being grabbed. When the text information corresponding to the operable control C is “do not reset”, the attribute information of the holdable object includes: the holdable object, upon being released in the grabbed state, not moving to the initial position before being grabbed.

Optionally, when the text information corresponding to the operable control D is “fixed position”, the attribute information of the holdable object includes: the holding position of the holdable object being a fixed position. If the text information corresponding to the operable control D is “any position”, the attribute information of the holdable object includes: the holding position of the holdable object not being a fixed position.

When the holding position of the holdable object is a fixed position, the holding position of the holdable object is the holding position most recently determined.

Optionally, under the condition that the holding position of the holdable object is any position, when the holding position of the holdable object set by the first user is a fixed position, the holding position of the holdable object is the holding position most recently determined.

Optionally, in S22, determining the position holding parameters of the holdable object according to the first position of the holdable object and the second position of the calibration object includes:

using the differences between the first position of the holdable object and the second position of the calibration object as the position holding parameters of the holdable object.

Optionally, the first position of the holdable object can be coordinate information of the holdable object in the above scene. The first user can drag the holdable object to adjust the first position of the holdable object.

Optionally, the second position of the calibration object can be coordinate information of the calibration object in the above scene.

In some optional embodiments provided in the present disclosure, for determining the second position, the method further includes:

in response to a movement operation of the first user on the calibration object, controlling the calibration object to move to the second position according to the movement operation of the first user. The movement operation can be a dragging operation.

Optionally, the first user can select the calibration object by clicking a relevant button such as the grab button on the handheld device, and then perform a movement operation on the calibration object.

In some optional embodiments provided in the present disclosure, for determining the second position, the method further includes S01 and S02:

S01. Acquiring the position of the center of the calibration object or the position of the bone point corresponding to the calibration object;

Optionally, the center of the calibration object can be the center of a circumscribed sphere of the space occupied by the calibration object.

Optionally, when the calibration object is a virtual hand, the position of the bone point corresponding to the calibration object can be a bone point corresponding to the wrist, or any other finger joint point. Referring to FIG. 4, FIG. 4 is a schematic diagram of the position of the bone point of the calibration object provided by one or more embodiments of the present disclosure. E is the geometric center point of the metacarpal bone corresponding to the middle finger of the palm. It can be understood that when the calibration object is a part of another virtual cartoon object, the bone point corresponding to the part can be determined.

S02. Using the position of the center or the position of the bone point corresponding to the calibration object as the second position.

In an optional embodiment provided by the present disclosure, the method further includes the following S01 and S02:

S01. Acquiring first posture information of the holdable object and second posture information of the calibration object; and

S02. In response to the determination instruction of the first user to determine the holding parameters of the holdable object, determining posture holding parameters of the holdable object according to the first posture information and the second posture information. The posture holding parameters are used to determine the posture of the holdable object after being held.

In some embodiments, the posture holding parameters can be parameters indicating the relative posture of the first posture information to the second posture information.

In an optional embodiment provided by the present disclosure, the method further includes: when the distance between the calibration object and the holdable object exceeding a first preset distance is detected, displaying a prompt message for indicating that the holding position is out of range. Optionally, the first preset distance can be 10 cm.

Optionally, the prompt message for indicating that the holding position is out of range can be a voice prompt message or a text prompt message. By means of this solution, when the first user calibrates the holding position of the holdable object, the fit between the calibration object and the holdable object is ensured, thereby improving the calibration efficiency of the user.

In an optional embodiment provided by the present disclosure, the method further includes: in response to the calibration instruction of the first user for the gesture information of the calibration object, determining gesture holding parameters of the holdable object according to the gesture information, the gesture holding parameters being used to define the holding gesture of the handheld object when the holdable object is being held. Determining the gesture holding parameters of the holdable object according to the gesture information can improve the flexibility of setting the holding gesture of the handheld object, and limiting the holding gesture of the handheld object when the holdable object gesture is being held can enhance the sense of immersion of the user in a scene, thereby improving user experience.

Optionally, after the first user releases the scene, display of the calibration object is canceled and the calibration object disappears. The relative position relationship between the second position where the calibration object last stayed and the first position is the position holding parameter.

Optionally, after determining the holding parameters of the holdable object, the method further includes the following S001 and S002.

S001. In response to the holding operation of the second user on the holdable object, acquiring control parameters of the control device of the second user.

Optionally, the second user and the first user can be the same user, or they can be different users.

Optionally, the holding operation of the second user on the holdable object can be a grabbing operation.

Optionally, the control device can be a handheld device.

Optionally, the handheld device is a handle.

Optionally, the handheld device can also be a glove.

S002. Displaying the holdable object according to the control parameters of the control device and the position holding parameters of the holdable object, the control parameters of the control device including position control parameters, or

Displaying the holdable object according to the control parameters of the control device and the posture holding parameters of the holdable object, the control parameters of the control device including position control parameters and posture control parameters.

It can be understood that the holdable object here can be determined according to the identification information of the holdable object, and the holdable object can exist in multiple scenes and there can be multiple holdable objects. That is, the holding parameters of the holdable object determined by the first user can be bound to each holdable object on the basis of the identification information of the holdable object.

Optionally, the control parameters of the handheld device can be parameters used to control the movement of the handheld device corresponding to the handheld object (i.e., the virtual object) in the scene. The handheld object can be a virtual hand or a virtual glove. The position holding parameters of the handheld device are parameters used to control the movement position of the handheld object.

Optionally, in the aforementioned S002, displaying the holdable object according to the control parameters of the control device and the position holding parameters of the holdable object includes:
determining a third position of the handheld object corresponding to the control device according to the control parameters of the control device;
acquiring a fourth position where the holdable object is currently located; and
displaying the holdable object on the basis of the third position, the fourth position, and the position holding parameters of the holdable object.

Displaying the holdable object on the basis of the third position, the fourth position, and the position holding parameters of the holdable object includes: determining whether the relative position relationship between the third position and the fourth position is consistent with the relative position relationship indicated by the position holding parameters of the holdable object. If they are consistents, the holdable object is controlled to be displayed following the handheld object; otherwise, no processing is performed.

Further, when the holding operation of the second user on the holdable object is a grabbing operation and the control device is a handheld device, the method further includes: in response to the grabbing operation of the second user on the holdable object, displaying the handheld object according to the gesture holding parameters.

Specifically, displaying the handheld object according to the gesture holding parameters can include:
determining the gesture information of the handheld object according to the control parameters of the handheld device; and
when the gesture information is consistent with the gesture information indicated by the gesture holding parameters, controlling the holdable object to be displayed following the handheld object.

In some optional embodiments, displaying the holdable object according to the control parameters of the handheld device and the posture holding parameters of the holdable object includes: according to the position control parameters in the control parameters of the handheld device, determining the third position of the handheld object corresponding to the handheld device; acquiring the fourth position where the holdable object is currently located; according to the posture control parameters in the control parameters of the handheld device, determining the third posture information corresponding to the handheld device; acquiring the current fourth posture information of the holdable object; and when the relative position relationship between the third position and the fourth position is consistent with the relative position relationship indicated by the position holding parameters of the holdable object, and when the relative posture of the third posture information to the fourth posture information is consistent with the relative posture indicated by the posture holding parameters of the holdable object, controlling the holdable object to be displayed following the handheld object.

Correspondingly, the above method further includes: when the relative posture of the fourth posture information to the third posture information is inconsistent with the relative posture relationship indicated by the posture holding parameters of the holdable object, adjusting the posture information of the holdable object, so that the relative posture of the fourth posture information to the third posture information is consistent with the relative posture indicated by the posture holding parameters of the holdable object.

The present disclosure provides the solution of displaying a holdable object and a calibration object for a first user to calibrate a holding position of the holdable object; and in response to a determination instruction for the first user to determine holding parameters of the holdable object, determining position holding parameters of the holdable object according to a first position of the holdable object and a second position of the calibration object. This solution allows the relevant person (first user) to adjust the position holding parameters of the holdable object by adjusting the second position where the displayed calibration object is located so as to achieve the purpose of flexibly calibrating the holding position of the holdable object, thereby enhancing the flexibility of setting the holding position of the holdable object and improving the user experience.

FIG. 5 is a schematic structural diagram of a data processing device provided by one or more exemplary embodiments of the present disclosure.

The device includes:
a display unit 51, configured to display a holdable object and a calibration object for a first user to calibrate the holding position of the holdable object; and
a determination unit 52, to determine, in response to a determination instruction of the first user to determine the holding parameters of the holdable object, position holding parameters of the holdable object according to a first position of the holdable object and a second position where the calibration object is located.

Optionally, the aforementioned device is further configured to: control, in response to a movement operation of the first user on the calibration object, the calibration object to move to the second position on the basis of the movement operation of the first user.

Optionally, the aforementioned device is further configured to: acquire first posture information of the holdable object and second posture information of the calibration object; and determine, in response to the determination instruction of the first user to determine the holding parameters of the holdable object, posture holding parameters of the holdable object according to the first posture information and the second posture information. The posture holding parameters are used to determine the posture of the holdable object after being held.

Optionally, the aforementioned device is further configured to: determine, in response to a calibration instruction of the first user for the gesture information of the calibration object, gesture holding parameters of the holdable object according to the gesture information, the gesture holding parameters being used to define the holding gesture of the handheld object when the holdable object is being held.

Optionally, the aforementioned device is further configured to: acquire a position of the center of the calibration object or a position of the bone point corresponding to the calibration object; and use the position of the center or the position of the bone point corresponding to the calibration object as the second position.

Optionally, the aforementioned device is further configured to: display a prompt message for indicating that the holding position is out of range when the distance between the calibration object and the holdable object exceeding a first preset distance is detected.

Optionally, the aforementioned device is further configured to: display a preset settings page; and determining the attributes of the holdable object according to the operation of the first user on the displayed operable control on the settings page. The settings page displays at least one of the following:
an operable control for the first user to set the release conditions of the holdable object in the grabbed state;
an operable control for the first user to set whether the holdable object, upon being released from the grabbed state, moves to the initial position before being grabbed; and
an operable control for the first user to set whether the holding position of the holdable object is a fixed position.

Optionally, the aforementioned device is further configured to: acquire control parameters of the control device of the second user in response to the holding operation of the second user on the holdable object; display the holdable object according to control parameters of the control device and position holding parameters of the holdable object, the control parameters of the control device including position control parameters, or display the holdable object according to control parameters of the control device and posture holding parameters of the holdable object, the control parameters of the control device including position control parameters and posture control parameters.

Optionally, the holding operation of the second user on the holdable object is a grabbing operation, the control device is a handheld device, and the aforementioned device is further configured to: display the handheld object according to the gesture holding parameters in response to the holding operation of the second user on the holdable object.

It should be understood that the device embodiments and the method embodiments can correspond to each other, and reference can be made to the method embodiments for similar descriptions. To avoid repetition, no further detail will be given herein. Specifically, the device can execute the above method embodiments, and the foregoing and other operations and/or functions of each module in the device are respectively the corresponding processes in each method in the above method embodiments. For the sake of brevity, no further detail will be given herein.

The device of the embodiments of the present disclosure is described above from the perspective of a functional module in conjunction with the accompanying drawings. It should be understood that this functional module can be implemented in the form of hardware, can also be implemented through instructions in the form of software, or can also be implemented through a combination of hardware and software modules. Specifically, each step of the method embodiments in the embodiments of the present disclosure can be completed by integrated logic circuits of hardware in the processor and/or instructions in the form of software. The steps of the methods disclosed in conjunction with the embodiments of the present disclosure can be directly implemented by a hardware decoding processor, or executed by a combination of hardware and software modules in the decoding processor. Optionally, the software module can be located in a mature storage medium in the field such as random access memory, flash memory, read-only memory, programmable read-only memory, electrically erasable programmable memory and register. The storage medium is located in the memory, and the processor reads the information in the memory and completes the steps in the above method embodiments in combination with the hardware thereof.

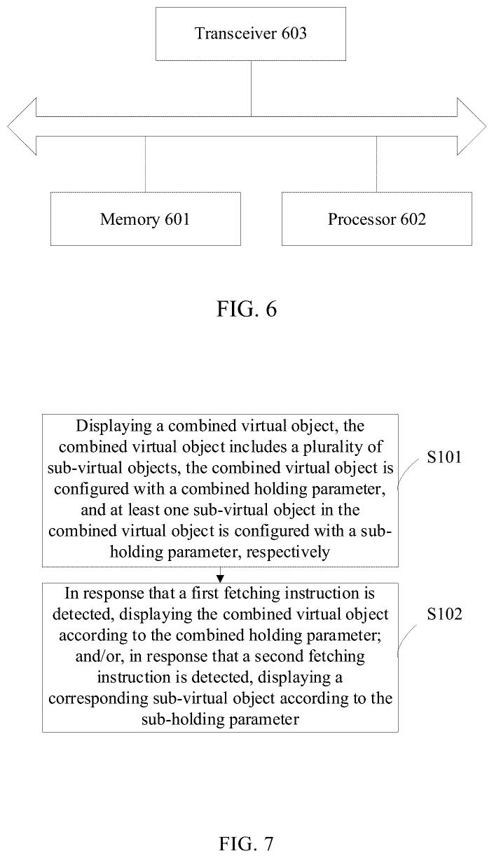

FIG. 6 is a schematic block diagram of an electronic device provided by the embodiments of the present disclosure. The electronic device can include: a memory 601 and a processor 602. The memory 601 is configured to store computer programs and transmit the program code to the processor 602. In other words, the processor 602 can call and run the computer program from the memory 601 to implement the method in the embodiments of the present disclosure.

For example, the processor 602 can be configured to execute the above method embodiments according to instructions in the computer program.

In some embodiments of the present disclosure, the processor 602 can include but is not limited to: a general processor, a digital signal processor (DSP), an application specific integrated circuit (ASIC), a field programmable gate array (FPGA) or any other programmable logic device, a discrete gate or transistor logic device, a discrete hardware component, and the like.

In some embodiments of the present disclosure, the memory 601 includes but is not limited to: a volatile memory and/or non-volatile memory. The non-volatile memory can be a read-only memory (ROM), a programmable read-only memory (PROM), an erasable programmable read-only memory (EPROM), an electrically erasable programmable read-only memory (EEPROM) or a flash memory. The volatile memory can be a random access memory (RAM), which is used as an external cache. By means of illustration, but not limitation, many forms of RAMs are available, such as static random access memory (SRAM), dynamic random access memory (DRAM), synchronous dynamic random access memory (SDRAM), double data rate synchronous dynamic random access memory (DDRSDRAM), enhanced synchronous dynamic random access memory (ESDRAM), synch link dynamic random access memory (SLDRAM) and direct rambus random access memory (DRRAM).

In some embodiments of the present disclosure, the computer program can be divided into one or more modules, and the one or more modules are stored in the memory 601 and executed by the processor 602 so as to complete the method provided by the present disclosure. The one or more modules can be a series of computer program instruction segments capable of completing specific functions. The instruction segments are used to describe the execution process of the computer program in the electronic device.

As illustrated in FIG. 6, the electronic device can also include: a transceiver 603. The transceiver 603 can be connected to the processor 602 or the memory 601.

The processor 602 can control the transceiver 603 to communicate with other devices. Specifically, the processor 602 can send information or data to other devices, or receive information or data sent by other devices. The transceiver 603 can include a transmitter and a receiver. The transceiver 603 can further include an antenna, and there can be one or more antenna(s).

It should be understood that various components in the electronic device are connected through a bus system. In addition to a data bus, the bus system also includes a power bus, a control bus and a status signal bus.

The present disclosure also provides a computer storage medium. A computer program is stored on the computer storage medium. The computer program enables the computer to execute the method embodiments mentioned above when executed by the computer. Alternatively, the embodiment of the present disclosure also provides a computer program product containing instructions. The instructions cause the computer to execute the method embodiment mentioned above when executed by a computer.

When implemented using software, it can be fully or partially implemented in the form of computer program products. This computer program product includes one or more computer instructions. When loading and executing the computer program instructions on the computer, all or part of the process or function according to the embodiments of the present disclosure is generated. This computer can be a general-purpose computer, a specialized computer, a computer network, or other programmable device. The computer instruction can be stored in a computer-readable storage medium, or transmitted from one computer-readable storage medium to another. For example, the computer instruction can be transmitted from a website, a computer, a server or data center to another website site, computer, server or data center through wired (such as coaxial cable, fiber optic, digital subscriber line (DSL)) or wireless (such as infrared, wireless, microwave, etc.) methods. The computer-readable storage medium can be any available medium that the computer can access, or a data storage device such as a server, data center, etc. which integrates one or more available media. The available media can be magnetic media (such as a floppy disk, a hard drive, a magnetic tape), optical media (such as digital video disc (DVD)), or semiconductor media (such as solid state disk (SSD)), etc.

FIG. 7 is a flow chart of a method for holding a virtual object provided by one or more embodiments of the present disclosure. The method is applied to an electronic device, and the electronic device includes but is not limited to an XR device, a mobile phone, a computer, a wearable device, etc. As shown in FIG. 7, the method provided by the present embodiment includes the following steps.

S101. Displaying a combined virtual object. The combined virtual object includes a plurality of sub-virtual objects, the combined virtual object is configured with a combined holding parameter, and at least one sub-virtual object in the combined virtual object is configured with a sub-holding parameter, respectively.

The combined virtual object can be a virtual prop. In the game scene, the virtual prop is also called a game prop, and the combined virtual object can be called a combined prop.

The combined virtual object can be displayed in the virtual scene or in the user's backpack. After the user opens the backpack, the combined virtual object is displayed in the backpack.

In the game scene, the backpack refers to a storage space (also called a storage bar) on the game role (avatar). In the game scene, a certain number of storage bars will be set on the avatar, so that the avatar can place game equipment and game props, meanwhile the backpack will also display the amount of virtual currency owned by the avatar.

The virtual scene can be a scene provided by the client itself or a scene defined by the user. Taking an XR device as an example, in order to meet the personalized needs of the user, UGC function is added, that is, the user can customize a virtual scene in the editor provided by the game according to his/her own needs, and the virtual scene customized by the user is also called the user's own world, and other users can enter the virtual scene customized by the user to play.

The editor can provide some editing elements, such as polyhedra, controls, materials, physics, logic, music, sound effects, special effects and source material, etc., for the user to use. The user can not only customize the virtual scene in the editor, but also customize props. The props customized by the user can be called UGC props. Similarly, the virtual scene customized by the user can be called a UGC world or a UGC scene. Customization in the embodiment of the present disclosure can be understood as that the an object or scene formed by the user's self-construction in the editor by using the editing elements provided by the editor.

In the virtual scene, there are not only combined virtual objects, but also independent virtual objects. The independent virtual object is relative to the combined virtual object, the combined virtual object refers to a virtual object composed of a plurality of sub-virtual objects, and each sub-virtual object is an independent virtual object.

The meaning of “composed of” here can be understood as that when the combined virtual object is released, the plurality of sub-virtual objects composing the combined virtual object are released as a whole. For example, basketball and basketball hoop can be independent virtual objects, or they can be released as a whole as a combined virtual object. For the combined virtual object, the combined virtual object can be held as a whole, or the sub-virtual objects in the combined virtual object can be held. For independent virtual objects, the independent virtual objects are held.

The independent virtual object refers to a virtual object composed of multiple geometric bodies, the geometric bodies can be understood as the smallest non-detachable editing elements in the editor, and the user can hold the independent virtual object.

After defining a combined virtual object, it is necessary to configure holding parameters for the combined virtual object before the user can hold, take and put, or fetch the combined virtual object. For example, the combined virtual object is taken out of the user's backpack, or the combined virtual object is taken from one place to another in the virtual scene, or the combined virtual object is held to perform tasks in the virtual scene.

In the embodiment of the present disclosure, two types of holding parameters are configured for the combined virtual object: a combined holding parameter and a sub-holding parameter. One combined virtual object is configured with only one combined holding parameter, and each sub-virtual object in the combined virtual object is configured with one sub-holding parameter. It can be understood that some sub-virtual objects in the combined virtual object may not be configured with sub-holding parameters.

The combined holding parameter can be understood as a virtual holding parameter, which is used to hold the entire combined virtual object, and the combined holding parameter can be understood as a holding parameter configured for the outermost parent nodes of the plurality of sub-virtual objects. When the user takes the combined virtual object out of the backpack, the combined virtual object is taken out of the backpack as a whole according to the combined holding parameter, and after the combined virtual object is taken out, the sub-virtual object can be taken and put according to the sub-holding parameter of the sub-virtual object.

For example, the combined holding parameter at least includes a combined position parameter, and the sub-holding parameter at least includes a sub-position parameter. The combined position parameter is used to describe the holding position when the avatar fetches and holds the virtual object, and the sub-position parameter is used to describe the holding position when the avatar holds the sub-virtual object, wherein the holding position of the combined virtual object and the holding position of the sub-virtual object can be expressed by three-dimensional coordinates.

Optionally, the combined holding parameter further includes a combined posture parameter, and/or the sub-holding parameter further includes a sub-posture parameter. The combined posture parameter is used to describe the posture of the combined virtual object, and the posture of the combined virtual object can be understood as the orientation or direction of the combined virtual object. The sub-posture parameter is used to describe the posture of the sub-virtual object, and the posture of the sub-virtual object can be understood as the orientation or direction of the sub-virtual object.

It should be noted that in the embodiment of the present disclosure, holding, fetching, or taking and putting the combined virtual object or the independent virtual object can be understood as that the hand of the avatar is in contact with the combined virtual object or the independent virtual object; or that the hand of the avatar is not in contact with the combined virtual object or the independent virtual object, and there is a certain distance therebetween, but the hand of the avatar can control the movement of the combined virtual object or the independent virtual object.

In addition, when a combined virtual object or an independent virtual object is held, it can be configured to be held by one hand or two hands, and the information of one-hand holding and two-hands holding can be included in the holding parameters.

S102, in response that a first fetching instruction is detected, displaying the combined virtual object according to the combined holding parameter; and/or, in response that a second fetching instruction is detected, displaying a corresponding sub-virtual object according to the sub-holding parameter.

The first fetching instruction is used to instruct to fetch the combined virtual object. The second fetching instruction is used to instruct to fetch the sub-virtual objection, the first fetching instruction and the second fetch instruction can be an instruction input by the user through the controller of the XR device, or an instruction input by means of gesture, voice, etc., which is not limited in the embodiment of the present disclosure.

When receiving the first fetching instruction on the combined virtual object, the combined virtual object is displayed according to the combined holding parameter, and the displaying here can be understood as displaying that the avatar fetches or holds the combined virtual object by hand according to the combined holding parameter. Similarly, displaying the corresponding sub-virtual object according to the sub-holding parameter can be understood as displaying that the avatar fetches or holds the sub-virtual object by hand according to the sub-holding parameters.

For example, in the embodiment of the present disclosure, the combined holding parameter at least includes a combined position parameter, and the sub-holding parameter at least includes a sub-position parameter. Correspondingly, in response that the first fetching instruction is detected, the combined virtual object is displayed according to the combined holding parameter and a control parameter, and/or in response that the second fetching instruction is detected, the corresponding sub-virtual object is displayed according to the control parameter and the sub-holding parameter. The control parameter includes a position parameter, and the position parameter is used to describe the position of the hand of the virtual role holding the combined virtual object and the sub-virtual object. When the user fetchs the combined virtual role, the display position of the combined virtual role can be determined by computering the combined holding parameters and the control parameters. Since the hand of the virtual role is usually displayed according to the control parameter, the combined virtual object will move following the hand of the virtual role, which reflects the hand of the virtual role holding the combined virtual object.

Similarly, when the user fetchs a sub-virtual object, the display position of the sub-virtual objection can be determined by computering the sub-holding parameters and the control parameters. Since the hand of the virtual role is usually displayed according to the control parameter, the sub-virtual object will move following the hand of the virtual role, which reflects the hand of the virtual role holding the combined virtual object. It should be noted that, the combined virtual objection is displayed according to the combined holding parameter and the control parameter, respective sub-virtual objects of the combined virtual objection can be located in a preset position, and also be maintained in the current relative portion, and in this case, the combined virtual object can be understood as a bounding box containing the respective sub-virtual objects.

the combined holding parameter can further include a combined posture parameter and/or the sub-holding parameter can further include a sub-posture parameter. When the user fetchs the combined virtual object, the display position and posture of the combined virtual object are determined by computering the holding parameter and the control parameter. When the user fetchs a sub-virtual object, the display position and posture of the sub-virtual object are determined by computering the sub-holding parameter and the control parameter.

When the method in the present embodiment is applied to an XR device, the control parameter is a control parameter of the controller of the XR device, and the controller of the XR device can be a handheld control device, such as a handle, a glove, etc. The control parameter of the controller include a position parameter and a posture parameter of the controller, and in XR scene, the position parameter and the posture parameter of the hand of the virtual role generally correspond to the position parameter and the posture parameter of the controller reflect.

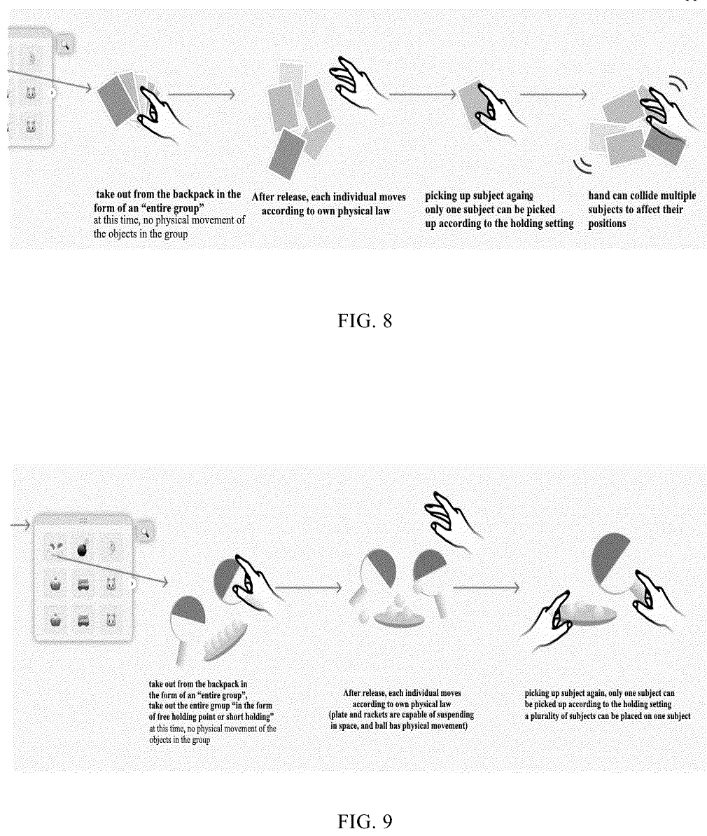

FIG. 8 is a schematic diagram of holding a combined virtual object. As shown in FIG. 8, the avatar needs to take out a deck of playing cards from the user's backpack, and the combined virtual object is a deck of playing cards. The user needs to open the user's backpack first, and a thumbnail of the playing cards is displayed in the user's backpack. The user can control the virtual hand model to click the thumbnail of the playing cards, and then, the hand model takes out the whole deck of playing cards from the user's backpack in the form of an “entire group”, and takes it out in the form of free holding point or short holding. The holding point can be understood as the holding position of the combined virtual object, and the short holding refers to the release of the combined virtual object after releasing the button when holding the combined virtual object. Optionally, there is no physical movement of the objects in the group during the taking-out process.

After released by the hand model, each playing card in the whole deck of playing cards moves according to a preset physical law. For example, each playing card falls onto the ground or a fixed object according to the law of gravity, or is suspended in space. The user can select to pick up the whole deck of playing cards again, or he/she only picks up one playing card of them at each time according to the sub-holding parameter of each playing card. Optionally, when the hand model fetches a single playing card, it can touch other playing cards, and the collision will affect the positions of other playing cards, so that the operation on the combined virtual object in the virtual scene is consistent with the operation on the real object in the real environment, thus bringing the user an immersive experience.

FIG. 9 is another schematic diagram of holding a combined virtual object. As shown in FIG. 9, the virtual role needs to take out a combined virtual object consisting of a pair of table tennis rackets, a plurality of table tennis balls and a plate from the user's backpack. The user needs to open the user's backpack first, and a thumbnail of the combined virtual object is displayed in the user's backpack. The hand model clicks the thumbnail, and then, the hand model takes out two table tennis rackets, a plurality of table tennis balls and one plate from the user's backpack in the form of an “entire group”. Optionally, there is no physical movement of the objects in the group during the taking-out process.

After released by the hand model, each sub-virtual object moves according to a preset physical law. For example, the plate and rackets are suspended in space, and the ball has physical movement. The ball moves and falls on or off the plate. When the subjects are picked up again, one subject can be picked up according to the holding parameter of the sub-virtual object, and multiple objects can be placed on one object. For example, the plurality of table tennis balls can be placed on the plate, and the plate and the table tennis balls on the plate can be picked up as a whole.

In the scenes shown in FIGS. 8 and 9, the user needs to firstly take the combined virtual object out of the user's backpack as a whole according to the combined holding parameter, and then he/she can fetches each sub-virtual object according to the sub-holding parameter of each sub-virtual object. Of course, the scenes of the embodiment of the present disclosure are not limited to these scenes. When playing in the virtual scene, the virtual role can also move the combined virtual object from one place to another; and in this scene, the fetching of the combined virtual object and the fetching of the sub-virtual object can be triggered by different fetching instructions.

In the present embodiment, a combined virtual object is displayed, the combined virtual object includes a plurality of sub-virtual objects, the combined virtual object is configured with a combined holding parameter, and at least one sub-virtual object in the combined virtual object is configured with a sub-holding parameter, respectively; in response that a first fetching instruction is detected, the combined virtual object is displayed according to the combined holding parameter; and/or, in response that a second fetching instruction is detected, a corresponding sub-virtual object is displayed according to the sub-holding parameter. In this method, the combined virtual object is configured with the combined holding parameter and the sub-holding parameters, and the entire combined virtual object can be held through the combined holding parameter, and each sub-virtual object in the combined virtual object can be held through the sub-holding parameter. It can not only holding the combined virtual object to implement the operation of moving a plurality of sub-virtual objects at a same time, etc. which is more convenient, but also holding a sub-virtual object of them to perform the operation of moving the sub-virtual object, etc., which is more flexible.

On the basis of the above embodiment, on or more embodiments of the present disclosure provides a method for holding a virtual object. The present embodiment focuses on the configuration of holding parameters of a combined virtual object, and configuring the combined holding parameter and the sub-holding parameters for the combined virtual object after the combined virtual object is created. In one implementation, after the combined virtual object is created, the combined holding parameter and the sub-holding parameters are automatically configured for the combined virtual object, which does not require the user to perform any operation, and can avoid the user forgetting to set the holding parameters. In another implementation, after the combined virtual object is created, the user manually configures the combined holding parameter and the sub-holding parameter for the combined virtual object.

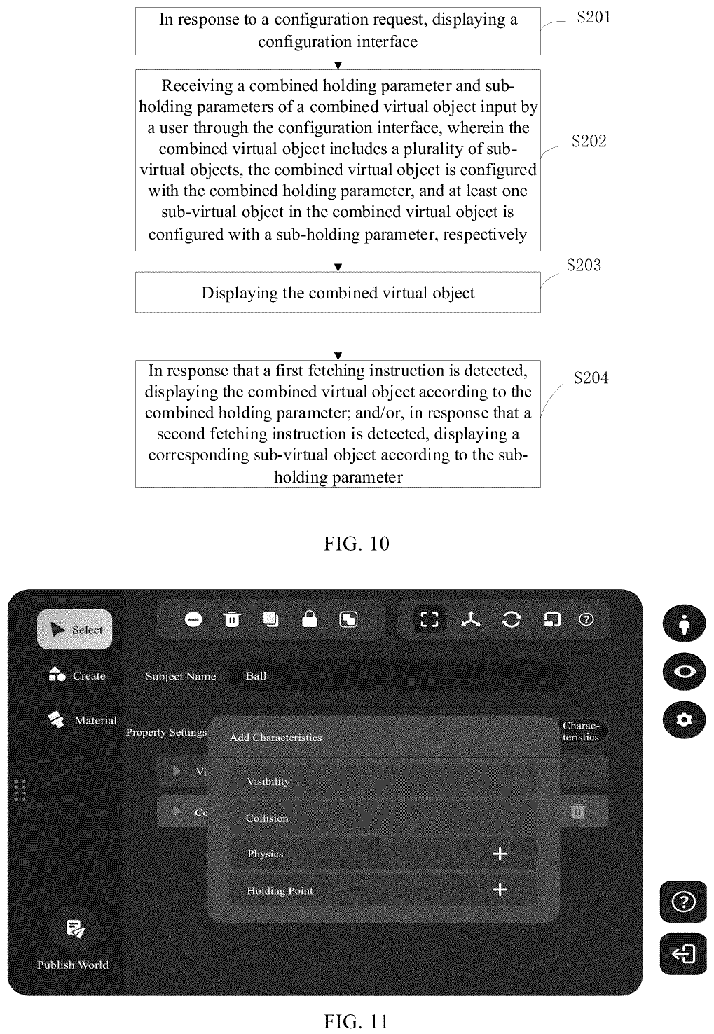

FIG. 10 is a flow chart of a method for holding a virtual object provided by one or more embodiments of the present disclosure. The present embodiment is illustrated by taking manual configuration as an example. As shown in FIG. 4, the method provided in the present embodiment includes the following steps.

S201. In response to a configuration request, displaying a configuration interface.

After the combined virtual object is created, the user can send a configuration request under any circumstances. For example, when the combined virtual object is released, a configuration request is triggered; or when the user needs to fetch the combined virtual object, it is found that the combined virtual object is not configured with holding parameters, then a configuration request is triggered.

S202. Receiving a combined holding parameter and sub-holding parameters of a combined virtual object input by a user through the configuration interface, wherein the combined virtual object includes a plurality of sub-virtual objects, the combined virtual object is configured with the combined holding parameter, and at least one sub-virtual object in the combined virtual object is configured with a sub-holding parameter, respectively.

For example, the combined holding parameter include three parameters: grabbing mode, object reset and grabbing position; and each parameter has multiple values for the user to select. For example, the grabbing mode includes releasing the button to release and releasing the button without releasing. Releasing the button to release means that when the user fetches the combined virtual object, if the button is released (for example, the button of the controller is released), the combined virtual object will leave the hand of the virtual role. Releasing the button without releasing means that the combined virtual object will not leave the hand of the virtual role after the button is released, that is, the combined virtual object will always follow the movement of the user's hand. Releasing the button to release is also called short holding, and releasing the button without releasing is also called long holding.

Object reset refers to whether the position of the object is reset after the virtual role releases the button, that is, whether the object returns to the default position.

The grabbing position refers to a position grabbed by the hand when the hand of the virtual role grabs the combined virtual object. The grabbing position can be a free position or a fixed position. The free position means that the specific grabbing position is not limited. After the grabbing position of the combined virtual object is set as free position, the left and right hand models corresponding to the holding position will be generated on the combined virtual object. The fixed position can be defined by the user himself/herself, or several positions can be provided for the user to select.

The sub-holding parameter also includes grabbing mode, object reset and grabbing position, which have the same functions as the three parameters in the combined holding parameter, and the setup process thereof is similar.

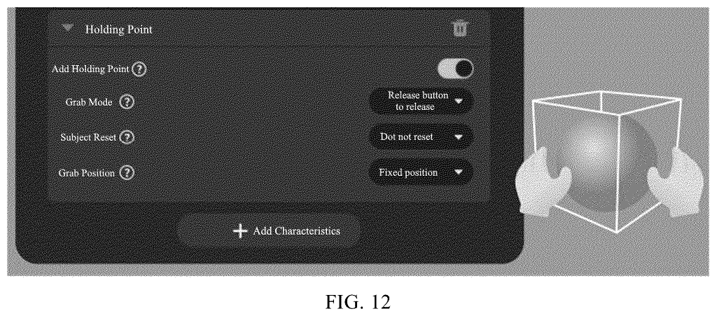

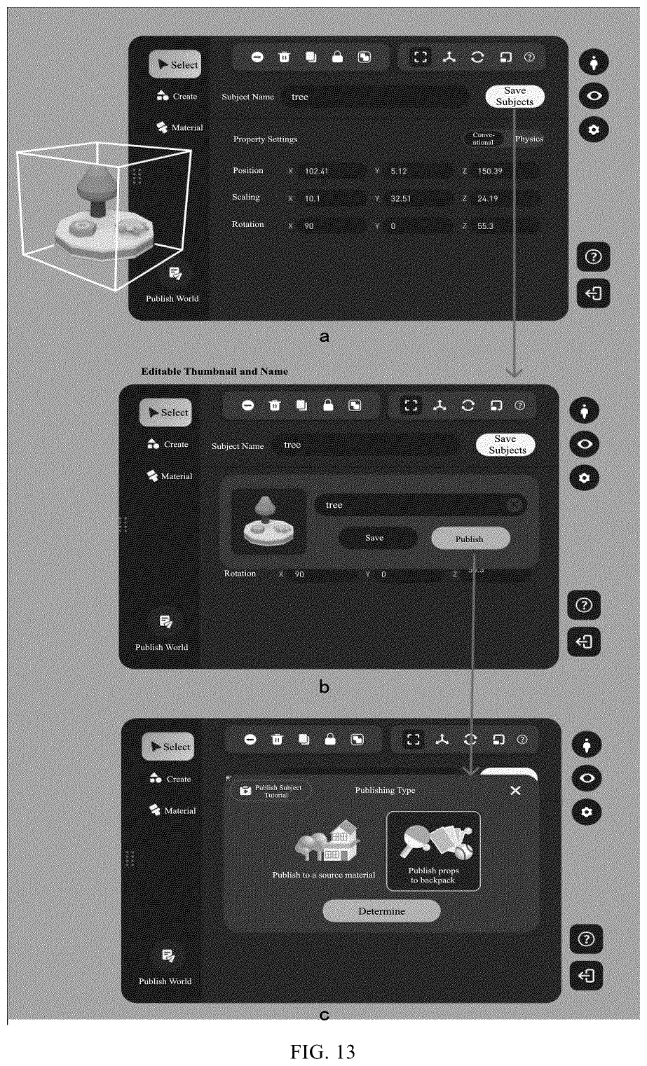

FIG. 11 is a schematic diagram of an entry of a configuration interface of holding parameters of a combined virtual object. As shown in FIG. 11, the user opens a parameter setup interface of the combined virtual object, and the parameter setup interface can include the parameters required for the setup of the combined virtual object. The “holding point” in the parameter setup interface is the entry of the configuration interface of the holding parameters of the combined virtual object, and after the user clicks the “holding point”, the configuration interface is entered.

Optionally, the configuration interface further includes a combined holding parameter configuration option and a sub-holding parameter configuration option. After the user selects the combined holding parameter configuration option, the configuration interface of the combined holding parameter is entered, and after the user selects the sub-holding parameter configuration option, the configuration interface of the sub-holding parameters is entered.

FIG. 12 is a schematic diagram of a configuration interface of a combined holding parameter or a sub-holding parameter. As shown in FIG. 12, the configuration interface includes a switch control for adding holding points. After the user selects to add holding points, the parameters of grabbing mode, object reset and grabbing position set by the user will take effect. If the user selects not to add holding points, the parameters of grabbing mode, object reset and grabbing position set by the user will not take effect.

S203. Displaying the combined virtual object.

S204. in response that a first fetching instruction is detected, displaying the combined virtual object according to the combined holding parameter; and/or, in response that a second fetching instruction is detected, displaying a corresponding sub-virtual object according to the sub-holding parameter.

The specific implementation of steps S203 and S204 refers to the description of the embodiment, and details will not be repeated here.

In the method of the present embodiment, the user is provided with the setting function of the holding parameters of the combined virtual object, and the user can selects to configure the combined holding parameter and/or sub-holding parameters for the combined virtual object according to his/her own needs, so that the configuration of the holding parameters of the combined virtual object is more flexible and meets the personalized needs of different users.

For a combined virtual object customized by the user, holding parameters can be set for the combined virtual object in the publishing process of the combined virtual object. In the editing space of the editor, the user can single-select or multi-select virtual objects to publish props, single-selected virtual objects published as independent virtual objects, multi-selected virtual objects published as a combined virtual object.

Taking the multi-selected publishing as an example, the user publishes a deck of playing cards, and multi-selects all cards to publish. When used in a virtual scene, a deck of cards can be drawn out, and each card can be individually drawn for playing.

FIG. 13 is a schematic diagram of the transformation of a publishing interface after the virtual object is created, and FIG. 13 is a schematic diagram of publishing an independent virtual object. The publishing process of a combined virtual object is the same as the publishing process of an independent virtual object. As shown in FIG. 13, after creating a virtual object in the editor, the user clicks the “Save Subject” control shown in FIG. 13(a) to save the virtual object, and the interface is transformed to that shown in FIG. 13(b); after the user clicks the “Publish” control, the interface is transformed to that shown in FIG. 13(c). The interface shown in FIG. 13(c) displays two types of publishing for the user to select: publishing to the source material library and publishing props to the backpack. Only the virtual objects published as props need to be configured with holding parameters, while the virtual objects published as source materials do not need to be configured with holding parameters.

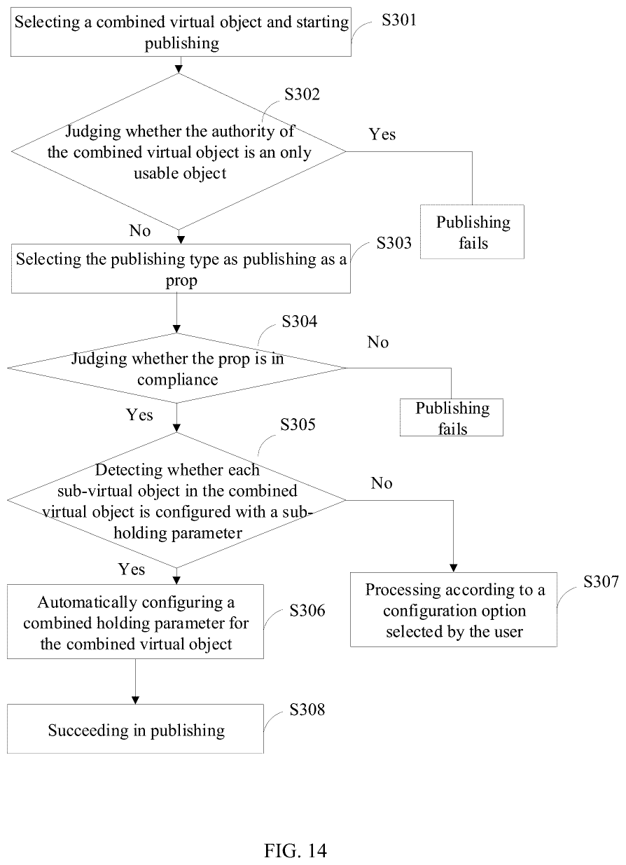

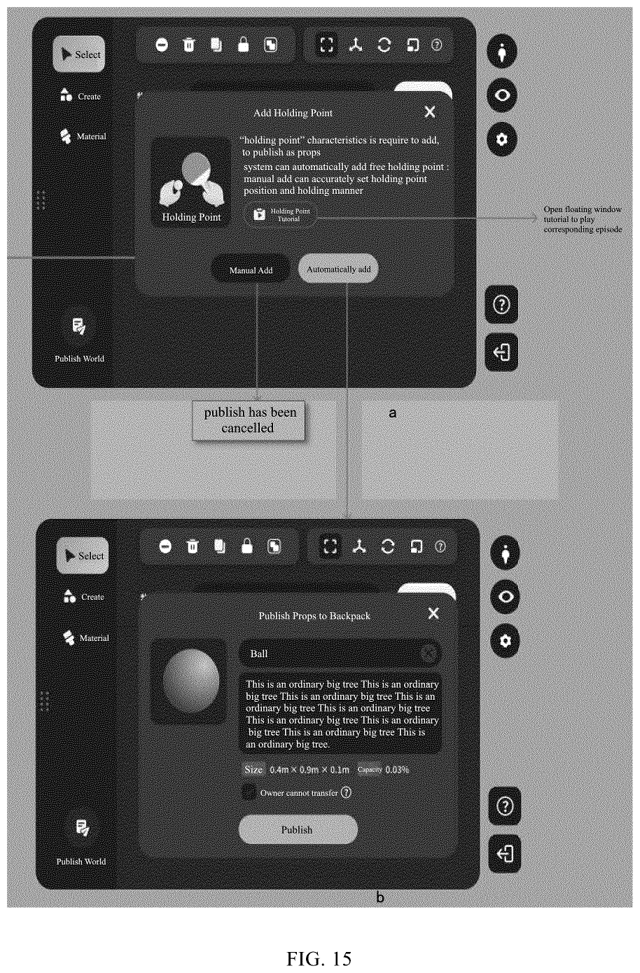

FIG. 14 is a schematic diagram of the publishing flow of a combined virtual object provided by the one or more embodiments of the present disclosure. As shown in FIG. 8, the method provided by the present embodiment includes the following steps.

S301. Selecting a combined virtual object and starting publishing.

S302. Judging whether the authority of the combined virtual object is an only usable object.

If the authority of the combined virtual object is an only usable object, it is determined that the publishing fails. If the authority of the combined virtual object is not an only usable object, step S303 is executed.

S303. Selecting the publishing type as publishing as a prop.

Publishing types include publishing as a source material and publishing as a prop. When the user selects publishing as a prop, step S304 is executed. If the user selects publishing as a source material, the publishing flow of the source material is executed, and details will not be described here.

S304. Judging whether the prop is in compliance.

For example, it is judged whether one or more of the size, capacity or asset type of the prop is in compliance, and if it is in compliance, step S305 is executed, and if it is not in compliance, it is determined that the publishing fails.

S305. Detecting whether each sub-virtual object in the combined virtual object is configured with a sub-holding parameter.

If all sub-virtual objects in the combined virtual object are configured with sub-holding parameters, step S306 is executed, and if any sub-virtual object in the combined virtual object is not configured with a sub-holding parameter, step S307 is executed.

S306. Automatically configuring a combined holding parameter for the combined virtual object.

S307: Processing according to a configuration option selected by the user.

The configuration options include automatic configuration and manual configuration. When the user selects manual configuration, processing according to the configuration option selected by the user includes: closing the publishing process and displaying a first prompt message, the first prompt message being used to prompt that the publishing of the combined virtual object has been cancelled.

When the user selects automatic configuration, processing according to the configuration option selected by the user includes: automatically configuring sub-holding parameters for sub-virtual objects that are not configured with sub-holding parameters in the combined virtual object; after all sub-virtual objects in the combined virtual object are configured with sub-holding parameters, automatically configuring a combined holding parameter for the combined virtual object; after the configuration of the combined holding parameter is completed, determining that the combined virtual object is published successfully.

For example, after the user selects publishing props to the backpack in FIG. 13(c), the interface switches to that shown in FIG. 15(a). After the user selects manual configuration, that is, “manually add” in the figure, it is prompted through the prompt box that the publishing has been cancelled, that is, the publishing process has been interrupted, and the user needs to manually configure a sub-holding parameter for each sub-virtual object, and then restart the publishing process. If the user selects automatic configuration, that is, “automatically add” in the figure, the interface switches to that shown in FIG. 15(b), that is, the automatic configuration of the sub-holding parameters will not interrupt the publishing process, and the user clicks the “Publish” control in FIG. 15(b), then the publishing is successful. If the user selects to cancel the publishing in the step shown in FIG. 15(b), the sub-holding parameters automatically configured in the previous step will not disappear and are still valid, and the user does not need to set the sub-holding parameters again when publishing next time.

Optionally, FIG. 15(a) further includes a “holding point tutorial”, and the “holding point tutorial” is used to demonstrate the setting process of holding parameters, so that the user who adopts manual configuration can quickly understand the setting method of holding parameters.

Optionally, in some other embodiments of the present disclosure, when any sub-virtual object in the combined virtual object is not configured with a sub-holding parameter, the following prompt message, “The current object is not configured with a holding parameter, and only the holdable object can be published to the backpack”, is displayed while the configuration options are displayed.

S308: Succeeding in publishing.

S308 is executed after step S306, that is, after the configuration of the combined holding parameter is completed, it is determined that the combined virtual object is published successfully. Alternatively, if the user selects automatic configuration in step S307, step S308 is executed after automatically configuring the combined holding parameter and the sub-holding parameters for the combined virtual object.

In the present embodiment, in the publishing process of the combined virtual object, it is detected whether each sub-virtual object in the combined virtual object is configured with a sub-holding parameter, and if each sub-virtual object is configured with a sub-holding parameter, the combined virtual object is automatically configured with the sub-holding parameter; if any sub-virtual object in the combined virtual object is not configured with a sub-holding parameter, configuration options are displayed, the configuration options includes automatic configuration and manual configuration, and holding parameters are automatically or manually configured for the combined virtual object according to the configuration option selected by the user, thus improving the flexibility of the configuration of the combined virtual object.

It should be emphasized that an independent virtual object is displayed in the virtual scene, the independent virtual object is configured with a holding parameter, and in response that a third fetching instruction is detected, the independent virtual object is displayed according to the holding parameter of the independent virtual object. The third fetching instruction is used to instruct fetching the independent virtual object, and the third fetching instruction can be the instruction input by the user through the controller of XR device, and also can be instructions input by gesture, voice, and so on. The independent virtual object is different from the combined virtual object in that the independent virtual object has only one holding parameter, which has the same function as the sub-holding parameter of each sub-virtual object in the combined virtual object. The configuration manner and function thereof refer to the relevant description of the holding parameter of each sub-virtual object in the combined virtual object, details will not be repeated in the embodiment of the present disclosure.

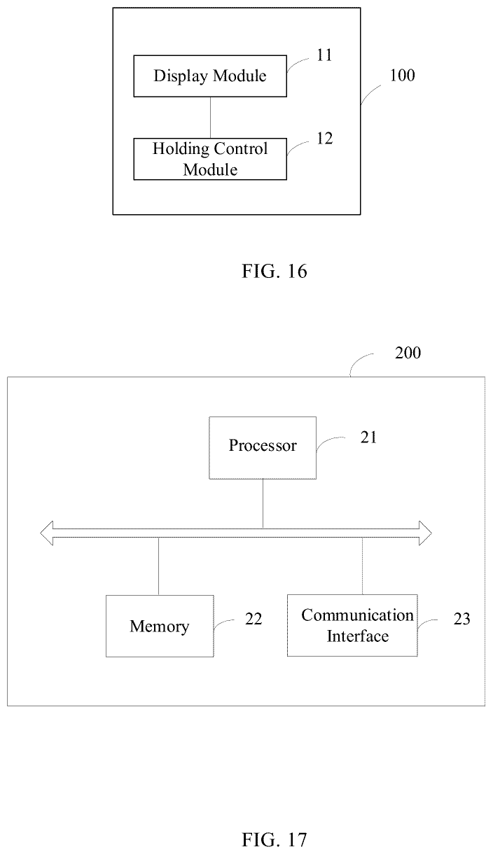

In order to better implement the method for holding a virtual object in the embodiment of the present disclosure, one or more embodiments of the present disclosure further provide an apparatus for holding a virtual object. FIG. 16 is a schematic structural diagram of an apparatus for holding a virtual object provided by one or more embodiments of the present disclosure. As shown in FIG. 16, the apparatus 100 for holding a virtual object can include:
a display module 11, configured to display a combined virtual object, wherein the combined virtual object includes a plurality of sub-virtual objects, the combined virtual object is configured with a combined holding parameter, and at least one sub-virtual object in the combined virtual object is configured with a sub-holding parameter, respectively;
a holding control module 12, configured to display, in response that a first fetching instruction is detected, the combined virtual object according to the combined holding parameter; and/or, to display, in response that a second fetching instruction is detected, a corresponding sub-virtual object according to the sub-holding parameter.

In some embodiments, the combined holding parameter at least includes a combined position parameter, and the sub-holding parameter at least includes a sub-position parameter;
the holding control module 12 is specifically configured to:
display, in response that the first fetching instruction is detected, the combined virtual object according to a control parameter and the combined holding parameter, wherein the control parameter includes a position parameter;
display, in response that the second fetching instruction is detected, the corresponding sub-virtual object according to the control parameter and the sub-holding parameter.

In some embodiments, the combined holding parameter further includes a combined posture parameter, and/or the sub-holding parameter further includes a sub-posture parameter; and the control parameter further includes a posture parameter.

In some embodiments, the control parameter is a control parameter of a controller of an XR device.

In some embodiments, the apparatus further includes a configuring module configured to configure the combined holding parameter and the sub-holding parameters for the combined virtual object.

In some embodiments, the configuring module is specifically configured to:
display, in response to a configuration request, a configuration interface;
receiving the combined holding parameter and the sub-holding parameters input by a user through the configuration interface.

In some embodiments, the configuring module is specifically configured to automatically configure the combined holding parameter and the sub-holding parameters for the combined virtual object after the combined virtual object is created.

In some embodiments, the configuring module is specifically configured to:
detect whether each sub-virtual object in the combined virtual object is configured with a sub-holding parameter in a publishing process of the combined virtual object;
if each sub-virtual objects is configured with a sub-holding parameter, automatically configure the combined holding parameter for the combined virtual object;
determine, after the configuration of the combined holding parameter is completed, that the combined virtual object is published successfully;
if any sub-virtual object in the combined virtual object is not configured with a sub-holding parameter, display configuration options, wherein the configuration options include automatic configuration and manual configuration;
process according to the configuration option selected by the user.

In some embodiments, when the user selects manual configuration, the configuration module is specifically configured to close the publishing process and display a first prompt message, wherein the first prompt message is used to prompt that the publishing of the combined virtual object has been cancelled.

In some embodiments, when the user selects automatic configuration, the configuration module is specifically configured to:
automatically configure sub-holding parameters for sub-virtual objects that are not configured with sub-holding parameters in the combined virtual object;
automatically configuring the combined holding parameter for the combined virtual object after all the virtual objects in the combined virtual object are configured with sub-holding parameters;
determine, after the configuration of the combined holding parameter is completed, that the combined virtual object is published successfully.

In some embodiments, the display module 11 is further configured to display an independent virtual object, wherein the independent virtual object is configured with a holding parameter;
the holding control module 12 is further configured to display, in response that a third fetching instruction is detected, the independent virtual object according to the holding parameter of the independent virtual object.

It should be understood that the apparatus embodiments and the method embodiments can correspond to each other, and reference can be made to the method embodiments for similar descriptions. To avoid repetition, no further detail will be given herein.

The apparatus 100 of the embodiments of the present disclosure is described above from the perspective of a functional module in conjunction with the accompanying drawings. It should be understood that this functional module can be implemented in the form of hardware, can also be implemented through instructions in the form of software, or can also be implemented through a combination of hardware and software modules. Specifically, each step of the method embodiments in the embodiments of the present disclosure can be completed by integrated logic circuits of hardware in the processor and/or instructions in the form of software. The steps of the methods disclosed in conjunction with the embodiments of the present disclosure can be directly implemented by a hardware decoding processor, or executed by a combination of hardware and software modules in the decoding processor. Optionally, the software module can be located in a mature storage medium in the field such as random access memory, flash memory, read-only memory, programmable read-only memory, electrically erasable programmable memory and register. The storage medium is located in the memory, and the processor reads the information in the memory and completes the steps in the above method embodiments in combination with the hardware thereof.

One or more embodiments of the present disclosure further provide an electronic device. FIG. 17 is a schematic structural diagram of an electronic device provided by one or more embodiments of the present disclosure. As shown in FIG. 17, the electronic device 200 can include: a memory 21 and a processor 22. The memory 21 is configured to store computer programs and transmit the program code to the processor 22. In other words, the processor 22 can call and run the computer program from the memory 21 to implement the method in the embodiments of the present disclosure.

For example, the processor 22 can be configured to execute the above method embodiments according to instructions in the computer program.

In some embodiments of the present disclosure, the processor 22 can include but is not limited to: a general processor, a digital signal processor (DSP), an application specific integrated circuit (ASIC), a field programmable gate array (FPGA) or any other programmable logic device, a discrete gate or transistor logic device, a discrete hardware component, and the like.

In some embodiments of the present disclosure, the memory 21 includes but is not limited to: a volatile memory and/or non-volatile memory. The non-volatile memory can be a read-only memory (ROM), a programmable read-only memory (PROM), an erasable programmable read-only memory (EPROM), an electrically erasable programmable read-only memory (EEPROM) or a flash memory. The volatile memory can be a random access memory (RAM), which is used as an external cache. By means of illustration, but not limitation, many forms of RAMs are available, such as static random access memory (SRAM), dynamic random access memory (DRAM), synchronous dynamic random access memory (SDRAM), double data rate synchronous dynamic random access memory (DDRSDRAM), enhanced synchronous dynamic random access memory (ESDRAM), synch link dynamic random access memory (SLDRAM) and direct rambus random access memory (DRRAM).

In some embodiments of the present disclosure, the computer program can be divided into one or more modules, and the one or more modules are stored in the memory 21 and executed by the processor 22 so as to complete the method provided by the present disclosure. The one or more modules can be a series of computer program instruction segments capable of completing specific functions. The instruction segments are used to describe the execution process of the computer program in the electronic device.

As shown in FIG. 17, the electronic device can further include a transceiver 23. The transceiver 23 can be connected to the processor 22 or the memory 21.

The processor 22 can control the transceiver 23 to communicate with other devices. Specifically, the processor 22 can send information or data to other devices, or receive information or data sent by other devices. The transceiver 23 can include a transmitter and a receiver. The transceiver 23 can further include an antenna, and there can be one or more antenna(s).

It can be understood that although not shown in FIG. 17, the electronic device 200 can further include a camera module, a wireless fidelity (WIFI) module, a positioning module, a Bluetooth module, a display, a controller, etc., which will not be described in detail here.

It should be understood that various components in the electronic device are connected through a bus system. In addition to a data bus, the bus system further includes a power bus, a control bus and a status signal bus.

The present disclosure further provides a computer storage medium. A computer program is stored on the computer storage medium. The computer program enables the computer to execute the method embodiments mentioned above when executed by the computer. Alternatively, the embodiment of the present disclosure also provides a computer program product containing instructions. The instructions cause the computer to execute the method embodiment mentioned above when executed by a computer.

The present disclosure further provides a computer program product. The computer program product includes a computer program, and the computer program is stored in a computer-readable storage medium. The processor of the electronic device reads the computer program from the computer-readable storage medium, and the processor executes the computer program, so that the electronic device executes the corresponding flow in the method for controlling the user position in the virtual scene in the embodiment of the present disclosure. Details are not repeated here for brevity.

On or more embodiments of the present disclosure provides a method for determining holding parameters, comprising: displaying a holdable object, and a calibration object for a first user to calibrate a holding position of the holdable object; and in response to a determination instruction of the first user to determine the holding parameters of the holdable object, determining position holding parameters of the holdable object according to a first position of the holdable object and a second position of the calibration object.

According to one or more embodiments of the present application, the method further comprises: in response to a movement operation of the first user on the calibration object, controlling the calibration object to move to the second position on the basis of the movement operation of the first user.

According to one or more embodiments of the present disclosure, the method further comprising: acquiring first posture information of the holdable object and second posture information of the calibration object; and in response to the determination instruction of the first user to determine the holding parameters of the holdable object, determining posture holding parameters of the holdable object according to the first posture information and the second posture information. The posture holding parameters are used to determine a posture of the holdable object after being held.

According to one or more embodiments of the present disclosure, the method further comprising: in response to a calibration instruction of the first user for gesture information of the calibration object, determining gesture holding parameters of the holdable object according to the gesture information, the gesture holding parameters being used to define a holding gesture of a handheld object when the holdable object is being held.

According to one or more embodiments of the present disclosure, the method further comprising: acquiring a position of a center of the calibration object or a position of a bone point corresponding to the calibration object; and using the position of the center or the position of the bone point corresponding to the calibration object as the second position.

According to one or more embodiments of the present disclosure, the method further comprising: when a distance between the calibration object and the holdable object exceeding a first preset distance is detected, displaying a prompt message for indicating that the holding position is out of range.

According to one or more embodiments of the present disclosure, the method further comprising: displaying a preset settings page; and determining attributes of the holdable object according to an operation of the first user on a displayed operable control on the settings page, wherein the settings page displays at least one of the following: an operable control for the first user to set release conditions of the holdable object in a grabbed state; an operable control for the first user to set whether the holdable object, upon being released from the grabbed state, moves to an initial position before being grabbed; and an operable control for the first user to set whether a holding position of the holdable object is a fixed position.

According to one or more embodiments of the present disclosure, the method further comprising: in response to a holding operation of a second user on the holdable object, acquiring control parameters of a control device of the second user; displaying the holdable object according to the control parameters of the control device and position holding parameters of the holdable object, the control parameters of the control device comprising position control parameters, or displaying the holdable object according to the control parameters of the control device and the posture holding parameters of the holdable object, the control parameters of the control device comprising position control parameters and posture control parameters.

According to one or more embodiments of the present disclosure, the holding operation of the second user on the holdable object is a grabbing operation, the control device is a handheld device, and the method further comprises: in response to the grabbing operation of the second user on the holdable object, displaying the handheld object according to gesture holding parameters.

One or more embodiments of the present disclosure further provides a data processing apparatus, comprising: a display unit, configured to display a holdable object and a calibration object for a first user to calibrate a holding position of the holdable object; and a determination unit, configured to determine, in response to a determination instruction of the first user to determine holding parameters of the holdable object, position holding parameters of the holdable object according to a first position of the holdable object and a second position of the calibration object.

According to one or more embodiments of the present disclosure, the apparatus is further configured to in response to a movement operation of the first user on the calibration object, control the calibration object to move to the second position on the basis of the movement operation of the first user

According to one or more embodiments of the present disclosure, the apparatus is further configured to acquire first posture information of the holdable object and second posture information of the calibration object; and in response to the determination instruction of the first user to determine the holding parameters of the holdable object, determine posture holding parameters of the holdable object according to the first posture information and the second posture information, wherein the posture holding parameters are used to determine a posture of the holdable object after being held.

According to one or more embodiments of the present disclosure, the apparatus is further configured to in response to a calibration instruction of the first user for gesture information of the calibration object, determine gesture holding parameters of the holdable object according to the gesture information, the gesture holding parameters being used to define a holding gesture of a handheld object when the holdable object is being held.

According to one or more embodiments of the present disclosure, the apparatus is further configured to acquiring a position of a center of the calibration object or a position of a bone point corresponding to the calibration object; and using the position of the center or the position of the bone point corresponding to the calibration object as the second position.

According to one or more embodiments of the present disclosure, the apparatus is further configured to when a distance between the calibration object and the holdable object exceeding a first preset distance is detected, display a prompt message for indicating that the holding position is out of range.

According to one or more embodiments of the present disclosure, the apparatus is further configured to display a preset settings page; and determine attributes of the holdable object according to an operation of the first user on a displayed operable control on the settings page. The settings page displays at least one of the following: an operable control for the first user to set release conditions of the holdable object in a grabbed state; an operable control for the first user to set whether the holdable object, upon being released from the grabbed state, moves to an initial position before being grabbed; and an operable control for the first user to set whether a holding position of the holdable object is a fixed position.

According to one or more embodiments of the present disclosure, the apparatus is further configured to in response to a holding operation of a second user on the holdable object, acquire control parameters of a control device of the second user; display the holdable object according to the control parameters of the control device and position holding parameters of the holdable object, the control parameters of the control device comprising position control parameters, or display the holdable object according to the control parameters of the control device and the posture holding parameters of the holdable object, the control parameters of the control device comprising position control parameters and posture control parameters.

According to one or more embodiments of the present disclosure, the holding operation of the second user on the holdable object is a grabbing operation, the control device is a handheld device, and the above apparatus is further configured to: in response to the grabbing operation of the second user on the holdable object, display the handheld object according to gesture holding parameters.

One or more embodiments of the present disclosure provides an electronic device, comprising a processor and a memory, configured to store executable instructions of the processor. The processor is configured to execute any of the above methods by executing the executable instructions.

One or more embodiments of the present disclosure provides a computer-readable storage medium on which a computer program is stored. When the computer program is executed by a processor, any of the above methods is implemented.

Those skilled in the art can recognized that the modules and algorithm steps described in the embodiments disclosed here can be implemented in electronic hardware, or a combination of computer software and electronic hardware. Whether these functions are executed in hardware or software depends on the specific disclosure and design constraints of the technical solution. Professionals can use different methods to achieve the described functions for each specific disclosure, but such implementation should not be considered beyond the scope of this disclosure.

In the several embodiments provided by the present disclosure, it should be understood that the disclosed system, apparatus, and method can be implemented in other ways. For example, the apparatus embodiments mentioned above are only illustrated as an example. For example, the division of the module is only a logical functional division, and there can be other division in practical implementation. For example, a plurality of modules or components can be combined or integrated into another system, or some features can be ignored or not executed. On the other hand, the coupling or direct coupling or communication connection shown or discussed between each other can be indirect coupling or communication connection through some interfaces, devices or modules, which can be electrical, mechanical or other forms.

The modules described as separate components can be or can not be physically separated, while the components shown as modules can be or can not be physical modules, which can be located in one place or distributed across multiple network units. Some or all modules can be selected according to actual needs to achieve the purpose of the embodiments. For example, respective functional modules of various embodiments of the present disclosure can be integrated into one processing module, respective modules can physically exist separately, or two or more modules can be integrated into one module.

The above is just the specific implementation of the present disclosure, but the scope of protection of the present disclosure is not limited to this. Those skilled in the art can easily think of changes or replacements within the scope of technology disclosed in the present disclosure which should be covered within the scope of protection of the present disclosure. Therefore, the protection scope of the present disclosure should be based on the protection scope of the claims.

What is claimed is:

1. A method for determining holding parameters, comprising:
displaying a holdable object, and a calibration object for a first user to calibrate a holding position of the holdable object; and
in response to a determination instruction of the first user to determine the holding parameters of the holdable object, determining position holding parameters of the holdable object according to a first position of the holdable object and a second position of the calibration object.

2. The method according to claim 1, further comprising:
in response to a movement operation of the first user on the calibration object, controlling the calibration object to move to the second position on the basis of the movement operation of the first user.

3. The method according to claim 1, further comprising:
acquiring first posture information of the holdable object and second posture information of the calibration object; and
in response to the determination instruction of the first user to determine the holding parameters of the holdable object, determining posture holding parameters of the holdable object according to the first posture information and the second posture information, wherein the posture holding parameters are used to determine a posture of the holdable object after being held.

4. The method according to claim 1, further comprising:
in response to a calibration instruction of the first user for gesture information of the calibration object, determining gesture holding parameters of the holdable object according to the gesture information, the gesture holding parameters being used to define a holding gesture of a handheld object when the holdable object is being held.

5. The method according to claim 1, further comprising:
acquiring a position of a center of the calibration object or a position of a bone point corresponding to the calibration object; and
using the position of the center or the position of the bone point corresponding to the calibration object as the second position.

6. The method according to claim 1, further comprising: when a distance between the calibration object and the holdable object exceeding a first preset distance is detected, displaying a prompt message for indicating that the holding position is out of range.

7. The method according to claim 1, further comprising: displaying a preset settings page; and determining attributes of the holdable object according to an operation of the first user on a displayed operable control on the settings page, wherein the settings page displays at least one of the following:
an operable control for the first user to set release conditions of the holdable object in a grabbed state;
an operable control for the first user to set whether the holdable object, upon being released from the grabbed state, moves to an initial position before being grabbed; and
an operable control for the first user to set whether a holding position of the holdable object is a fixed position.

8. The method according to claim 1, further comprising:
in response to a holding operation of a second user on the holdable object, acquiring control parameters of a control device of the second user;
displaying the holdable object according to the control parameters of the control device and position holding parameters of the holdable object, the control parameters of the control device comprising position control parameters, or
displaying the holdable object according to the control parameters of the control device and the posture holding parameters of the holdable object, the control parameters of the control device comprising position control parameters and posture control parameters.

9. The method according to claim 8, wherein the holding operation of the second user on the holdable object is a grabbing operation, the control device is a handheld device, and the method further comprises:
in response to the grabbing operation of the second user on the holdable object, displaying the handheld object according to gesture holding parameters.

10. An apparatus for determining holding parameters, comprising:
a display unit, configured to display a holdable object and a calibration object for a first user to calibrate a holding position of the holdable object; and
a determination unit, configured to determine, in response to a determination instruction of the first user to determine holding parameters of the holdable object, position holding parameters of the holdable object according to a first position of the holdable object and a second position of the calibration object.

11. An electronic device, comprising:
at least one processor; and
a memory, configured to store executable instructions of the processor;
wherein the at least one processor is configured to execute a method for determining holding parameters, and the method comprises displaying a holdable object, and a calibration object for a first user to calibrate a holding position of the holdable object, and in response to a determination instruction of the first user to determine the holding parameters of the holdable object, determining position holding parameters of the holdable object according to a first position of the holdable object and a second position of the calibration object.

12. A computer-readable storage medium on which a computer program is stored, wherein when the computer program is executed by a processor, the method claim 1 is implemented.
